(19) United States
(12) Patent Application Publication
(10) Pub. No.: US 2026/0310806 A1
(43) Pub. Date: Oct. 8, 2026

(54) ELECTRONIC APPARATUS AND METHOD FOR CONTROLLING THE SAME

(71) Applicant: SAMSUNG ELECTRONICS CO., LTD., Suwon-si (KR)

(72) Inventors: Van Hien NGUYEN, Hanoi (VN); The Nghia NGUYEN, Hanoi (VN)

(73) Assignee: SAMSUNG ELECTRONICS CO., LTD., Suwon-si (KR)

(21) Appl. No.: 19/680,042

(22) Filed: May 18, 2026

Related U.S. Application Data
(63) Continuation of application No. PCT/KR2024/097138, filed on Dec. 18, 2024.

(30) Foreign Application Priority Data
Dec. 18, 2023 (KR) 10-2023-0184771

(51) Int. Cl. G06F 21/62; G06F 21/32

(52) U.S. Cl. CPC G06F 21/6209; G06F 21/32; G06F 2221/2141

(57) ABSTRACT

A display apparatus and a method of controlling an electronic apparatus are provided. The electronic apparatus may store authentication data associated with a plurality of groups, receive a request for user authentication from a first application, based on first biometric information of a user regarding the request being obtained, identify whether the first biometric information is included in the authentication data, based on the first biometric information being included in the authentication data, determine whether a first group corresponding to the first application is identified from the plurality of groups, based on the first group being identified, and the first biometric information corresponding to authentication data included in the first group, allow the user to access the first application, and based on the first group not being identified, deny access to the first application for the user and provide a message requesting a group assignment for the first application.

### CROSS-REFERENCE TO RELATED APPLICATIONS

This is a continuation application of International Patent Application No. PCT/KR2024/097138, filed on Dec. 18, 2024, which claims priority to Korean Patent Application No. 10-2023-0184771, filed on Dec. 18, 2023, in the Korean Intellectual Property Office, the disclosures of which are incorporated herein by reference in their entireties.

### BACKGROUND

The present disclosure relates to an electronic apparatus and a method for controlling the same, and more particularly, to an electronic apparatus capable of improving the security of user authentication using biometric information, and a method for controlling the same.

Recently, with the advancement of technologies related to communication, artificial intelligence, and the Internet of Things (IoT), user authentication technologies using biometric recognition have continued to develop and have been innovatively applied across various fields.

However, while user authentication technologies using biometric recognition have advantages such as utilizing the uniqueness of individual users, providing a high level of security due to a high recognition rate, and enabling fast and convenient user authentication, they also have a drawback in that, if biometric information is misappropriated by a third party who is not an authorized user of an electronic apparatus, it may cause a serious leakage of personal information.

In particular, when a third party learns a passcode for unlocking a lock screen of an electronic apparatus and then adds his or her own biometric information to the electronic apparatus, the third party may illegally obtain the user's personal information by logging into or accessing various applications in which biometric authentication is enabled.

To address this issue, the related art provides a method in which, when new biometric information is added to an electronic apparatus, a message is provided to inform the user that the biometric information has been added, and biometric authentication for applications is disabled.

However, in the related art, if biometric authentication for applications is disabled every time new biometric information is added, a user must endure inconvenience of re-enabling the disabled biometric authentication by using a method such as inputting a passcode of a user account. On the other hand, if appropriate measures are not taken when new biometric information is added to the electronic apparatus, there is a limitation in that a serious security problem may be caused.

### SUMMARY

One or more embodiments of the present disclosure provide an electronic apparatus capable of improving security of user authentication using biometric information and a method of controlling the same.

In one or more embodiments, an electronic apparatus may include: memory storing authentication data associated with a plurality of groups; and a processor configured to: receive a request for user authentication from a first application; based on first biometric information of a user regarding the request being obtained, identify whether the first biometric information is included in the authentication data; based on the first biometric information being included in the authentication data, determine whether a first group corresponding to the first application is identified from the plurality of groups stored in the memory; based on the first group being identified, and the first biometric information corresponding to authentication data included in the first group, allow the user to access the first application; and based on the first group not being identified, deny access to the first application for the user and provide a message requesting a group assignment for the first application.

In one or more embodiments, a method of controlling an electronic apparatus may include: receiving a request for user authentication from a first application; based on first biometric information of a user regarding the request being obtained, identify whether the first biometric information is included in authentication data divided into a plurality of groups; based on the first biometric information being included in the authentication data, determine whether a first group corresponding to the first application is identified from the plurality of groups stored in the memory; based on the first group being identified, and the first biometric information corresponding to authentication data included in the first group, allowing the user to access the first application; and based on the first group not being identified, denying access to the first application for the user and providing a message requesting a group assignment for the first application.

In one or more embodiments, a non-transitory computer-readable storage medium storing one or more instructions which, when executed by one or more processors of an electronic apparatus, may cause the electronic apparatus to: store authentication data associated with a plurality of groups in a memory; based on a request for user authentication from a first application, obtain first biometric information of a user; identify whether the first biometric information matches reference biometric data within the authentication data; based on the first biometric information matching the reference biometric data, identify whether the first biometric information corresponds to a first group assigned to the first application among the plurality of groups; based on the first biometric information corresponding to the first group, allow the user to access the first application; and based on the first application not corresponding to the first group, deny the user's access to the first application and provide a message for requesting to set a group corresponding to the first application.

### BRIEF DESCRIPTION OF DRAWINGS

The above and/or other aspects will be more apparent by describing certain example embodiments, with reference to the accompanying drawings, in which:

FIG. 1 is a flowchart illustrating a controlling method of an electronic apparatus in one or more embodiments;

FIG. 2 is a view illustrating a data structure of authentication data according to one or more embodiments;

FIG. 3 is a flowchart illustrating a method of setting a group corresponding to a first application in one or more embodiments;

FIG. 4 is a flowchart illustrating a method deleting first biometric information after first biometric information is assigned to a second group in one or more embodiments;

FIG. 5 is a flowchart illustrating a method of allocating first biometric information to a third group after first biometric information is assigned to a second group in one or more embodiments;

FIG. 6 is a block diagram illustrating configuration of an electronic apparatus in one or more embodiments; and

FIG. 7 is a block diagram illustrating configuration of an electronic apparatus in one or more embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (e.g., a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, when any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform~” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

Meanwhile, various elements and regions in the drawings are schematically illustrated. Therefore, the spirit of the present disclosure is not limited by relative sizes or intervals illustrated in the accompanying drawings.

Hereinafter, an embodiment of the present disclosure is described in detail with reference to the accompanying drawings so that those skilled in the art to which the present disclosure pertains may easily practice the present disclosure.

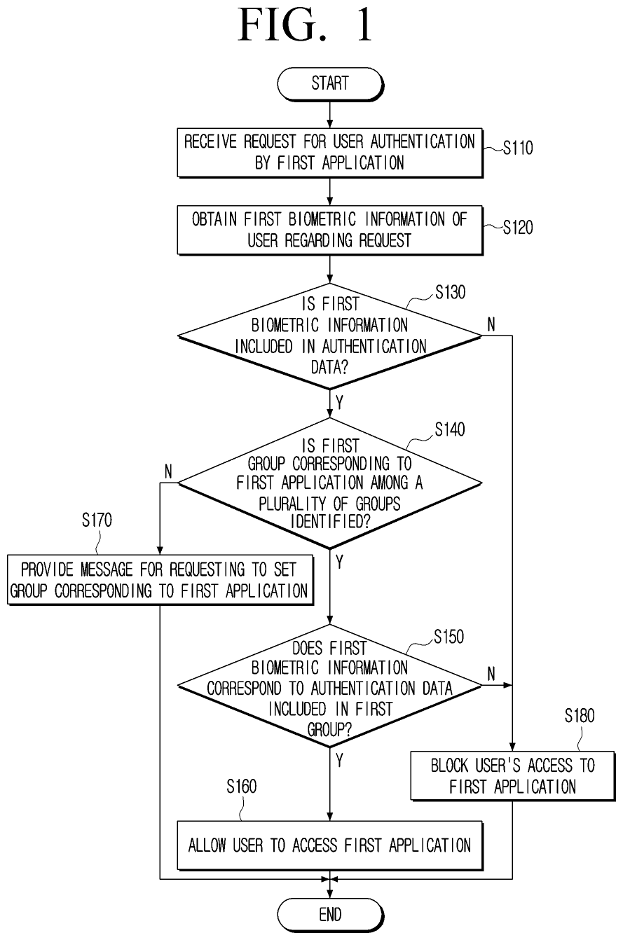

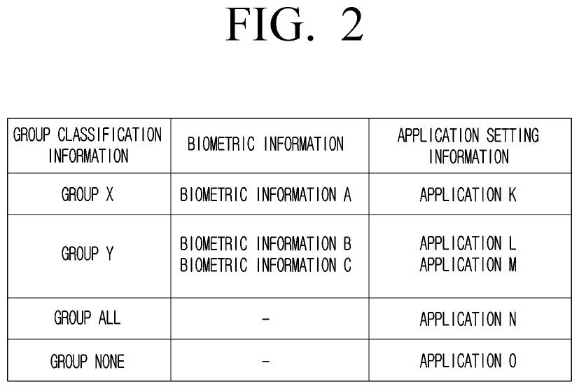

FIG. 1 is a flowchart illustrating a controlling method of an electronic apparatus 100 in one or more embodiments, and FIG. 2 is a view illustrating a structure of authentication data according to one or more embodiments.

As illustrated in FIG. 1, an electronic apparatus 100 may receive a request for user authentication by a first application (S110). The electronic apparatus 100 may trigger a user authentication request when the first application is opened. For example, the request for user authentication by the first application may be received based on the occurrence of an event such as execution of the first application, or may be received based on a user input such as a touch input by the user to perform a payment using the first application. The first application may ask for user authentication automatically upon launch, or may prompt the user during a specific action, such as a touch input to authorize a payment.

The term “user authentication” refers to a process of verifying an identity of a user when the user accesses various functions, information, or services provided by the electronic apparatus 100. In particular, user authentication may refer to a process of determining whether to allow the user to access various functions, information, or services provided by a specific application.

The term “first application” is used to specify one application among a plurality of applications that may be provided by the electronic apparatus 100, and there is no particular limitation on a type of the first application. In addition, terms such as a second application and a third application may also be used, like the term first application, to refer to specific applications in order to distinguish them from other applications.

The electronic apparatus 100 may obtain first biometric information of the user in response to the request for user authentication (S120). Specifically, when the request for user authentication by the first application is received, the user may input first biometric information of the user in response to the request for user authentication, and accordingly, the electronic apparatus 100 may obtain the first biometric information of the user.

The term “biometric information” collectively refers to information related to a user's biometrics for identifying the identity of the user. For example, biometric information may be information for identifying an individual user based on unique biometric characteristics such as a fingerprint, an iris, or a voice of the user. There is no particular limitation on a type of biometric information according to the present disclosure. The term “biometric information” may be replaced with terms such as “biometric recognition information” or “biometric authentication information.”

The term “first biometric information” is used to specify one piece of biometric information, and terms such as second biometric information and third biometric information may also be used, like the term first biometric information, to refer to specific biometric information in order to distinguish it from other biometric information. For example, the first biometric information may be fingerprint information input by the user (e.g., a scan of the user's thumbprint), the second biometric information may be different fingerprint information input by the user (e.g., a scan of the user's index fingerprint), and the third biometric information may be iris information input by the user (e.g., a scan of the user's iris).

When the first biometric information is obtained, the electronic apparatus 100 may identify whether the first biometric information is included in authentication data (S130). Here, the term “authentication data” refers to data built for user authentication, and may be replaced with terms such as “authentication database.” In particular, the authentication data according to the present disclosure may be data divided into a plurality of groups. Specifically, the authentication data may be data in which different biometric information is divided into a plurality of groups.

Specifically, whenever the electronic apparatus 100 obtains user biometric information, the electronic apparatus 100 may generate and store authentication data in memory 110 of the electronic apparatus 100. Subsequently, when new biometric information (such as the first biometric information in FIG. 1) is obtained, the electronic apparatus 100 may identify whether the new biometric information matches any existing authentication data.

Referring to FIG. 2, the authentication data may include group classification information, biometric information, and application setting information. As defined above, each piece of biometric information may be assigned to at least one group among a plurality of groups.

In the present disclosure, the term “group” refers to a set of biometric information for performing user authentication. Specifically, each piece of biometric information is mapped to a specific group, and each group may contain or correspond to at least one piece of biometric information. The term “group” may be interchangeable with terms such as a “biometric information group” or a “set of biometric information.”

The term “group classification information” refers to information for distinguishing a plurality of groups, and more specifically, refers to information for managing biometric information by allocating each piece of biometric information to at least one group among the plurality of groups. For example, as illustrated in FIG. 2, the group classification information may indicate that biometric information A is assigned to group X, and biometric information B and biometric information C are assigned to group Y. Meanwhile, the term “assign” may be used interchangeably with terms such as “designate,” or “place.”

The term “application setting information” refers to information indicating a group corresponding to each application in the authentication data. The application setting information may identify which group is required to unlock a specific application, and may link each application to a pre-authorized biometric group. Specifically, the application setting information refers to information indicating a group that is set for performing user authentication for each application.

In describing the present disclosure, a group that is set for performing user authentication for a specific application may be referred to as a “group corresponding to the application,” and may also be simply referred to as a “dedicated group,” a “designated group,” a “target group,” or an “assigned group.”

Specifically, when a first application is restricted to a specific group (e.g., only the specific group corresponds to the first application), the electronic apparatus 100 may use biometric information assigned to the specific group in a user authentication process for the first application, and may ignore biometric information assigned to other groups.

For example, as illustrated the example of FIG. 2, the application setting information indicates that group X is set as a group corresponding to application K, and group Y is set as a group corresponding to application L and application M. Meanwhile, group ALL in FIG. 2 indicates that all groups (that is, group X and group Y in the example of FIG. 2) are set as groups corresponding to application N, and group NONE in FIG. 2 indicates that no group is set as a group corresponding to application O. Meanwhile, the term “set” may be replaced with terms such as “select,” “designate,” or “assign.”

Hereinafter, among the plurality of groups, a group that is preset as corresponding to the first application may be referred to as a “first group.” In other words, the first group refers to a group that is set as corresponding to the first application before a request for user authentication is received.

The electronic apparatus 100 may determine that the first biometric information is included in the authentication data when the first biometric information matches reference biometric data within the authentication data. When the first biometric information is included in the authentication data (S130-Y), the electronic apparatus 100 may identify the first group corresponding to the first application among the plurality of groups (S140). Specifically, the electronic apparatus 100 may not complete user authentication or grant access solely because the first biometric information is included in the authentication data, but may additionally perform a process of identifying whether the first biometric information belongs to a specific group authorized for the first application (e.g., the first group set for performing user authentication for the first application) among the plurality of groups.

When the first biometric information is included in the authentication data and the first group corresponding to the first application is identified (S140-Y), the electronic apparatus 100 may identify whether the first biometric information corresponds to authentication data included in the first group (S150). When the first biometric information corresponds to the authentication data included in the first group (S150-Y), the electronic apparatus 100 may allow the user to access the first application (S160).

Here, the fact that the first biometric information corresponds to or match the authentication data included in the first group means that the first biometric information is identical or similar to stored data in the first group (e.g., at least one of biometric information corresponding to the first group). “Similarity” means any difference between captured features and stored features fall within a predetermined threshold.

In other words, when a group for performing user authentication for the first application is preset and the first biometric information is identical or similar to biometric information assigned to the preset group, the electronic apparatus 100 may determine that user authentication is successful and allow the user to access the first application.

For example, as illustrated in FIG. 2, if application K requests user authentication and the user provides biometric information A, the electronic apparatus 100 may allow the user to access application K because biometric information A is registered and specifically assigned to a group authorized for application K.

Meanwhile, when the first biometric information is included in the authentication data and therefore is recognized (S130-Y), but no authorized group has been set for the first application (S140-N), the electronic apparatus 100 may provide a message for requesting to set a group corresponding to the first application (S170).

In other words, even when the first biometric information is included in the authentication data, if a group corresponding to the first application has not yet been set, the electronic apparatus 100 may provide a message for requesting to set a group corresponding to the first application. Therefore, even if the user is known and registered in the electronic apparatus 100, if no specific group is linked to the first application, the electronic apparatus 100 may request that the user complete a group setup.

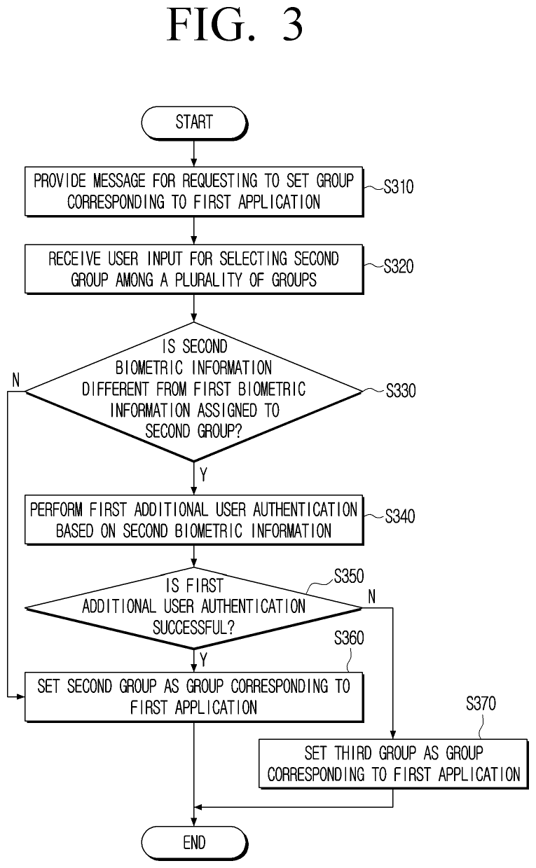

For example, as illustrated in an example of FIG. 2, when application O requests authentication and the user provides biometric information A that matches the pre-stored authentication data, the electronic apparatus 100 may ask the user to assign a group corresponding to application O because no group is currently assigned to application O. A process of setting a group corresponding to a specific application after providing a message for requesting to set a group corresponding to the specific application will be described in more detail with reference to FIG. 3.

Meanwhile, although the above has described a case in which the first biometric information is included in the authentication data (S130-Y), when the first biometric information is not found in the authentication data (S130-N), the electronic apparatus 100 may determine that user authentication has failed.

Specifically, when the first biometric information is not included in the authentication data, the electronic apparatus 100 may block or deny the user's access to the first application (S180), and provide a message indicating that user authentication for the first application has failed. For example, the electronic apparatus 100 may provide a message including information that the user's biometric information is not registered.

For example, as illustrated in an example of FIG. 2, if the user provides unregistered biometric information D in response to a request for user authentication by application K, the electronic apparatus 100 may block the user's access to application K since the biometric information D is not found in the authentication data.

Meanwhile, although the above has described a process of performing user authentication after receiving a request for user authentication by the first application, separately from this, the electronic apparatus 100 may perform a process of registering new biometric information of the user. Here, “registration” refers to including and storing biometric information of the user in the authentication data. In particular, the biometric information registration process according to the present disclosure may include a process of updating authentication data by allocating biometric information to at least one group among a plurality of groups.

Specifically, when a user input for registering first biometric information is received, the electronic apparatus 100 may obtain the first biometric information, and assign the biometric information of the first user to at least one group among the plurality of groups.

For example, when biometric information other than the first biometric information does not exist in the authentication data, the electronic apparatus 100 may assign a second group, which is a new group, with respect to the first biometric information. On the other hand, when second biometric information, which is biometric information other than the obtained biometric information, exists in the authentication data, the electronic apparatus 100 may assign a second group, which is a new group, with respect to the first biometric information, or may assign an existing group, which is a third group corresponding to the second biometric information. In particular, the electronic apparatus 100 may assign the first biometric information to a third group only when user authentication based on the second biometric information corresponding to the third group is successful.

Meanwhile, although the above has described a case in which the first biometric information corresponds to authentication data included in the first group (S130-Y, S140-Y, S150-Y), when the first biometric information does not correspond to authentication data included in the first group (S150-N), the electronic apparatus 100 may determine that user authentication has failed.

Specifically, when the first group corresponding to the first application is identified, but the first biometric information does not correspond to authentication data included in the first group, the electronic apparatus 100 may block the user's access to the first application (S180), and provide a message indicating that user authentication for the first application has failed because while the first biometric information is registered, the first biometric information is not authorized for the first application. In other words, when the first biometric information is not biometric information assigned to a group corresponding to the first application, the electronic apparatus 100 may determine that user authentication has failed, and provide a message including information that the first biometric information is not biometric information assigned to the group corresponding to the first application.

For example, as illustrated in an example of FIG. 2, when biometric information B is obtained in response to a request for user authentication by application K in a state in which the authentication data is built, although biometric information B is included in the authentication data and group X is assigned as a group corresponding to application K, since biometric information B is assigned to group Y rather than group X, the electronic apparatus 100 may block the user's access to application K.

Meanwhile, although the above has described an embodiment in which, when the first biometric information corresponds to authentication data included in the first group (S130-Y, S140-Y, S150-Y), user authentication is immediately determined to be successful and the user's access to the first application is allowed, the electronic apparatus 100 may further perform an additional process even when the first biometric information corresponds to authentication data included in the first group.

When the first group corresponding to the first application is identified and the first biometric information corresponds to authentication data included in the first group, the electronic apparatus 100 may perform user authentication based on comparing a first time at which a request for user authentication by the first application is received and a second time at which the first biometric information is input. Specifically, when the second time is later than the first time, the electronic apparatus 100 may block the user's access to the first application, and when the second time is earlier than or equal to the first time, the electronic apparatus 100 may allow the user's access to the first application.

According to the above-described embodiments with reference to FIGS. 1 and 2, the electronic apparatus 100 may assign a group to registered biometric information, and when performing user authentication for an application, may use only biometric information corresponding to a dedicated group for the application to verify the user's identity.

Accordingly, the electronic apparatus 100 may prevent a third party from registering his or her own biometric information and accessing applications provided by the electronic apparatus 100, and as a result, may improve security of user authentication using biometric information, without using a method that causes inconvenience to the user, such as disabling biometric authentication for applications.

FIG. 3 is a flowchart illustrating a method of setting a group corresponding to a first application in one or more embodiments.

As illustrated in FIG. 3, the electronic apparatus 100 may provide a message for requesting to set a group corresponding to the first application (S310). Specifically, as described above with reference to FIG. 1, when first biometric information is included in authentication data (S130-Y) but a first group is not identified (S140-N), the electronic apparatus 100 may provide a message for requesting to set a group corresponding to the first application (S170).

In other words, FIG. 3 is for explaining steps that may be performed after step S170 of FIG. 1, and assumes a case in which the first biometric information is included in the authentication data but no corresponding group has been identified for the first application.

The electronic apparatus 100 may receive a user input for selecting a second group among a plurality of groups (S320). Here, the “second group” is a term used to refer to a group selected, among the plurality of groups, as corresponding to the first application according to a user selection. In other words, the second group refers to a group selected as corresponding to the first application according to a user selection when a first group preset as corresponding to the first application is not identified.

Specifically, the electronic apparatus 100 may receive a user input in response to a setup request message for requesting to set a group corresponding to the first application. When the second group is selected among the plurality of groups according to the user input, the electronic apparatus 100 may set the second group as a group corresponding to the first application, assign the first biometric information to the second group, and allow the user's access to the first application.

In other words, when the second group is selected among the plurality of groups according to the user input, the electronic apparatus 100 may set the second group as the group corresponding to the first application without performing an additional process. However, when the second group is selected among the plurality of groups according to the user input, the electronic apparatus 100 may set the group corresponding to the first application by performing an additional process, as will be described below.

Meanwhile, the second group may be an existing group that already exists in the authentication data, or may be a new group. In other words, when the user input is for selecting the second group which is one of the groups existing in the authentication data, the electronic apparatus 100 may set the already-existing second group as the group corresponding to the first application. On the other hand, when the user input is for selecting the second group which is a new group that does not exist in the authentication data, the electronic apparatus 100 may generate the second group in the authentication data, and set the newly generated second group as the group corresponding to the first application.

The electronic apparatus 100 may identify whether second biometric information different from the first biometric information is assigned to the second group (S330). When the second biometric information different from the first biometric information is assigned to the second group, the electronic apparatus 100 may perform a first additional user authentication based on the second biometric information (S340).

The “first additional user authentication” refers to an authentication process performed to determine whether to assign the first biometric information to the second group together with the second biometric information during a user authentication process based on the first biometric information. The first additional user authentication process may be performed based on whether the user inputs biometric information identical to the second biometric information.

Specifically, when the second biometric information different from the first biometric information is assigned to the second group, the electronic apparatus 100 may request the user to input the second biometric information in order to determine whether to assign the first biometric information to the second group together with the second biometric information.

For example, as in the example of FIG. 2, when biometric information D (e.g., thumbprint D) is obtained in response to a request for user authentication by application K in a state in which authentication data is built, the electronic apparatus 100 may require biometric information A (e.g., a scan of index fingerprint A already in Group X) to determine if biometric information D can be added to Group X. The electronic apparatus 100 may perform the first additional user authentication based on biometric information A, which is biometric information assigned to group X corresponding to application L, and determine whether to assign biometric information D to group X together with biometric information A.

When the first additional user authentication is successful (S350-Y), the electronic apparatus 100 may set the second group as the group corresponding to the first application (S360). On the other hand, when the first additional user authentication fails (S350-N), the electronic apparatus 100 may set a third group different from the second group as the group corresponding to the first application (S370).

Specifically, when the electronic apparatus 100 requests the user to input the second biometric information and then biometric information identical to the second biometric information is input by the user, the electronic apparatus 100 may determine that the first additional user authentication is successful, set the second group as the group corresponding to the first application, and assign the first biometric information to the second group. Accordingly, both the first biometric information and the second biometric information corresponding to the second group may be used for user authentication for the first application.

On the other hand, when the electronic apparatus 100 requests the user to input the second biometric information and then biometric information identical to the second biometric information is not input by the user, the electronic apparatus 100 may determine that the first additional user authentication has failed, set a third group, which is a new group rather than the second group, as the group corresponding to the first application, and assign the first biometric information to the third group. Accordingly, the second biometric information corresponding to the second group cannot be used for user authentication for the first application, and only the first biometric information corresponding to the third group can be used for user authentication for the first application.

Meanwhile, when one or more groups among the plurality of groups are not selected by the user, the electronic apparatus 100 may set a fourth group (e.g., group ALL of FIG. 2), which is preset for performing user authentication for all applications among the plurality of groups, as the group corresponding to the first application. The fourth group may be set as a default group for universal application authentication.

According to the embodiments described above with reference to FIG. 3, when setting a group corresponding to an application, the electronic apparatus 100 may assign new biometric information to the group corresponding to the application only when user authentication is possible using already-registered biometric information, thereby effectively preventing a third party from registering his or her own biometric information and accessing the application.

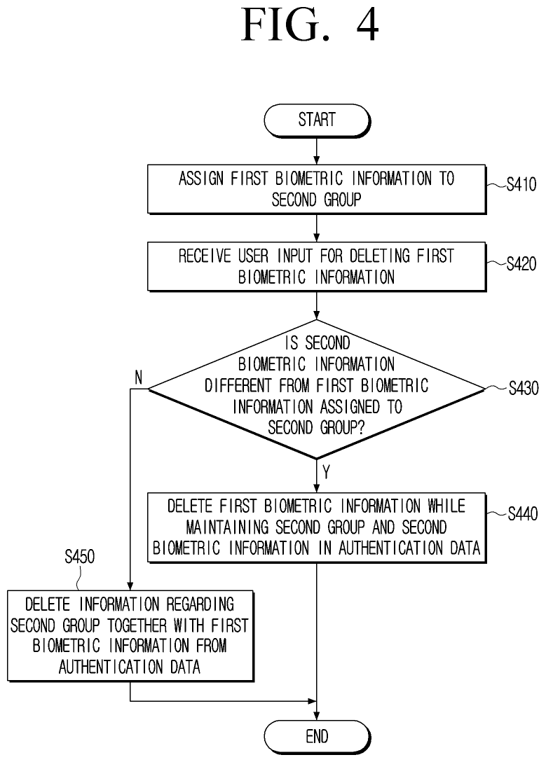

FIG. 4 is a flowchart illustrating a method of deleting first biometric information after first biometric information is assigned to a second group in one or more embodiments.

The electronic apparatus 100 may assign the first biometric information to the second group (S410).

After the first biometric information is assigned to the second group, the electronic apparatus 100 may receive a user input for deleting the first biometric information (S420). The user input for deleting the first biometric information may include a user input for preventing the first biometric information from being used for user authentication by deleting the already-registered first biometric information from the authentication data.

When the user input for deleting the first biometric information is received, the electronic apparatus 100 may identify whether second biometric information different from the first biometric information is assigned to the second group (S430).

When the second biometric information is assigned to the second group (S430-Y), the electronic apparatus 100 may delete the first biometric information while maintaining the second group and the second biometric information in the authentication data (S440). On the other hand, when the second biometric information is not assigned to the second group (S430-N), the electronic apparatus 100 may delete information on the second group together with the first biometric information from the authentication data (S450).

For example, as in the example of FIG. 2, when a user input requesting deletion of biometric information B is received in a state in which authentication data is built, the electronic apparatus 100 may identify whether biometric information different from biometric information B is assigned to group Y to which biometric information B is assigned.

In the example of FIG. 2, since biometric information C different from biometric information B is assigned to group Y, the electronic apparatus 100 may update the authentication data to delete only biometric information B while maintaining group Y and biometric information C. On the other hand, unlike the example of FIG. 2, if no biometric information other than biometric information B is assigned to group Y, there is no practical benefit in maintaining group Y. In such a case, the electronic apparatus 100 may update the authentication data to delete group Y together with biometric information B.

Meanwhile, when the second group is deleted in a state in which the second group is set as the group corresponding to the first application, the electronic apparatus 100 may set a fifth group (e.g., group NONE of FIG. 2), which is for an application for which there is no biometric information capable of performing user authentication, as the group corresponding to the first application. In one or more embodiments, when the second group is deleted, the electronic apparatus 100 may revert the first application to a default security state in which no biometric information is capable of performing user authentication.

Meanwhile, although the above description has been made on the assumption that a user input for deleting the first biometric information is received, the electronic apparatus 100 may receive a user input for deleting the second group. When the user input for deleting the second group is received, the electronic apparatus 100 may delete the second group together with all biometric information included in the second group from the authentication data.

Meanwhile, when data related to the first application is deleted after the first biometric information is assigned to the second group, the electronic apparatus 100 may delete, from the authentication data, information indicating that the second group is set for performing user authentication for the first application. Here, deletion of data related to the first application may include removal (i.e., uninstallation) of the first application or deletion of data related to various settings of the first application.

According to the embodiments described above with reference to FIG. 4, when deleting biometric information, the electronic apparatus 100 can ensure reliability in biometric information management by preventing other biometric information assigned to the same group as the biometric information to be deleted from being deleted together.

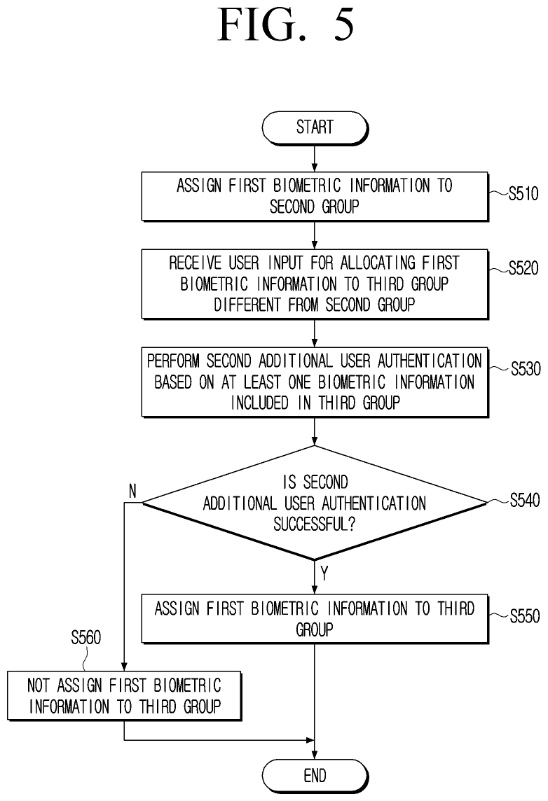

FIG. 5 is a flowchart illustrating a method of allocating first biometric information to a third group after first biometric information is assigned to a second group in one or more embodiments.

The electronic apparatus 100 may assign the first biometric information to the second group (S510).

The electronic apparatus 100 may receive a user input for assigning the first biometric information to a third group different from the second group (S520). The user input for assigning the first biometric information to the third group different from the second group may include a user input for assigning the first biometric information to the third group while maintaining the assignment of the first biometric information to the second group, or a user input for assigning the first biometric information to the third group while canceling the assignment of the first biometric information to the second group.

When the user input for assigning the first biometric information to the third group different from the second group is received, the electronic apparatus 100 may perform a second additional user authentication based on at least one biometric information included in the third group (S530).

The “second additional user authentication” refers to an authentication process performed based on at least one biometric information included in the third group according to the user input for assigning the first biometric information to the third group different from the second group. In other words, the second additional user authentication can be distinguished from the first additional user authentication (see FIG. 3), which is performed during a user authentication process based on the first biometric information, in that the second additional user authentication is performed according to a user input for assigning the first biometric information to the third group different from the second group.

Specifically, when at least one biometric information is included in the third group, the electronic apparatus 100 may request the user to input at least one biometric information included in the third group in order to determine whether to assign the first biometric information to the third group.

For example, as in the example of FIG. 2, when a user input for assigning biometric information A to group Y is received in a state in which authentication data is built, the electronic apparatus 100 may perform the second additional user authentication based on at least one of biometric information B or biometric information C included in group Y, and determine whether to assign biometric information A to group Y together with biometric information B and biometric information C.

When the second additional user authentication is successful (S540-Y), the electronic apparatus 100 may assign the first biometric information to the third group (S550). In contrast, when the second additional user authentication fails (S540-N), the electronic apparatus 100 may not assign the first biometric information to the third group and maintain an original assignment of the first biometric information to the second group (S560).

Specifically, after the electronic apparatus 100 requests input of at least one biometric information included in the third group, when biometric information identical to at least one biometric information included in the third group is input by the user, the electronic apparatus 100 may determine that the second additional user authentication is successful and assign the first biometric information to the third group. Accordingly, both the first biometric information and the at least one biometric information included in the third group may be used for user authentication for an application corresponding to the third group.

On the other hand, after the electronic apparatus 100 requests input of at least one biometric information included in the third group, when biometric information identical to at least one biometric information included in the third group is not input by the user, the electronic apparatus 100 may determine that the second additional user authentication has failed and may not assign the first biometric information to the third group. Accordingly, the first biometric information may still be used only for user authentication for the first application, and may not be used for user authentication for an application corresponding to the third group.

According to the embodiments described above with reference to FIG. 5, when adding or changing a group corresponding to a specific application, the electronic apparatus 100 allows the addition or change of the group corresponding to the specific application only when user authentication is possible using biometric information already assigned to the group corresponding to the specific application, thereby effectively preventing a third party from registering his or her own biometric information and accessing the application

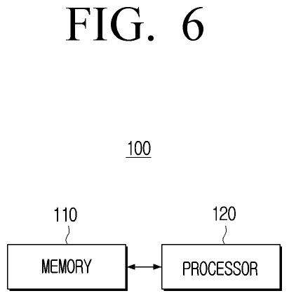

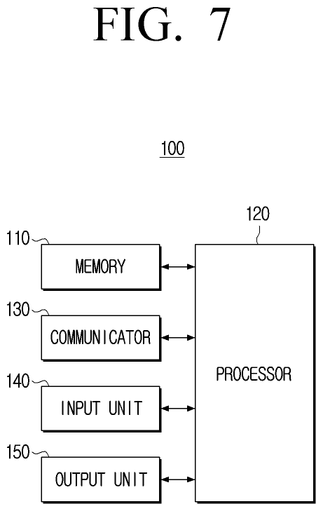

FIG. 6 is a block diagram illustrating configuration of the electronic apparatus 100 in one or more embodiments, and FIG. 7 is a block diagram illustrating configuration of the electronic apparatus 100 in one or more embodiments.

As illustrated in FIG. 6, the electronic apparatus 100 according to the present disclosure includes memory 110 and a processor 120. In addition, as illustrated in FIG. 7, the electronic apparatus 100 according to the present disclosure may further include a communicator 130, an input unit 140, and an output unit 150. However, the configurations illustrated in FIGS. 6 and 7 are merely exemplary, and additional components may be added or some components may be omitted when implementing the present disclosure.

The memory 110 may store at least one instruction related to the electronic apparatus 100. The memory 110 may also store an operating system for driving the electronic apparatus 100. In addition, the memory 110 may store various software programs, instructions, and/or applications for operating the electronic apparatus 100 according to various embodiments of the present disclosure. The memory 110 may include semiconductor memory such as flash memory or a magnetic storage medium such as a hard disk.

Specifically, the memory 110 may store various software modules for operating the electronic apparatus 100 according to various embodiments of the present disclosure, and the processor 120 may execute the various software modules stored in the memory 110 to control the operation of the electronic apparatus 100. In other words, the memory 110 is accessed by the processor 120, and reading, writing, modifying, deleting, and updating of data by the processor 120 may be performed.

Meanwhile, in the present disclosure, the term memory 110 may be used to include the memory 110 itself, ROM or RAM within the processor 120, or a memory card mounted in the electronic apparatus 100 (for example, a micro SD card or a memory stick).

In particular, in one or more embodiments, the memory 110 may store authentication data in which different biometric information is classified into a plurality of groups. Specifically, the memory 110 may store authentication data including group classification information, biometric information, and application setting information. In addition, the memory 110 may store information related to a message for requesting to set a group corresponding to a specific application, information related to a message indicating that user authentication has failed, information related to a request time of user authentication by an application, information related to a time at which biometric information is input, and the like.

In addition, various information necessary within a scope for achieving the purpose of the present disclosure may be stored in the memory 110, and the information stored in the memory 110 may be updated as the information is received from an external apparatus or input by a user.

The processor 120 controls overall operations of the electronic apparatus 100. Specifically, the processor 120 is connected to components of the electronic apparatus 100 including the memory 110, the communicator 130, the input unit 140, and the output unit 150, and may control overall operations of the electronic apparatus 100 by executing at least one instruction stored in the memory 110 as described above.

The processor 120 may be implemented in various manners. For example, the processor 120 may be implemented as at least one of an application specific integrated circuit (ASIC), an embedded processor, a microprocessor, hardware control logic, a hardware finite state machine (FSM), or a digital signal processor (DSP). Meanwhile, in the present disclosure, the term processor 120 may be used to include a central processing unit (CPU), a graphics processing unit (GPU), a micro processor unit (MPU), and the like.

In particular, in one or more embodiments, the processor 120 may receive a user authentication request by a first application. When first biometric information of a user is obtained in response to the user authentication request by the first application, the processor 120 may identify whether the first biometric information is included in the authentication data.

When the first biometric information is included in the authentication data, the processor 120 may identify a first group corresponding to the first application among a plurality of groups stored in the memory 110. Here, the plurality of groups stored in the memory 110 refer to a plurality of groups classifying the authentication data stored in the memory 110.

Specifically, the electronic apparatus 100 may not complete user authentication merely based on the fact that the first biometric information is included in the authentication data, and may additionally perform a process of identifying whether a group corresponding to the first application exists among the plurality of groups.

When the first group is identified, and the first biometric information corresponds to authentication data included in the first group, the processor 120 may allow a user's access to the first application. When the first group is not identified, the processor 120 may provide a message for requesting to set a group corresponding to the first application.

In one or more embodiments, the processor 120 may receive a user input in response to the message for requesting to set a group corresponding to the first application. When a second group is selected among the plurality of groups according to the user input, the processor 120 may set the second group as the group corresponding to the first application, assign the first biometric information to the second group, and allow the user's access to the first application.

In one or more embodiments, when second biometric information different from the first biometric information is assigned to the second group and the second group is selected according to the user input, the processor 120 may perform a first additional user authentication based on the second biometric information. As a result of performing the first additional user authentication, when the first additional user authentication is successful, the processor 120 may set the second group as a group corresponding to the first application. Further, when the first additional user authentication fails, the processor 120 may set a third group different from the second group as a group corresponding to the first application.

In one or more embodiments, when the first biometric information is not included in the authentication data, the processor 120 may block a user's access to the first application, and provide a message indicating that user authentication for the first application has failed.

In one or more embodiments, when the first biometric information does not correspond to authentication data included in the identified first group, the processor 120 may block a user's access to the first application, and provide a message indicating that user authentication for the first application has failed.

Descriptions of various embodiments of the present disclosure based on control by the processor 120 have been described above with reference to FIGS. 1 to 5, and thus redundant descriptions will be omitted.

The communicator 130 includes circuitry, and may perform communication with an external apparatus. The communicator 130 may be also referred to as a communication interface. Specifically, the processor 120 may receive various data or information from an external apparatus connected through the communicator 130, or may transmit various data or information to the external apparatus.

The communicator 130 may include at least one of a Wi-Fi module, a Bluetooth module, a wireless communication module, an NFC module, or a UWB module. Specifically, each of the Wi-Fi module and the Bluetooth module may perform communication according to a Wi-Fi scheme and a Bluetooth scheme, respectively. When using the Wi-Fi module or the Bluetooth module, various connection information such as an SSID may be transmitted and received in advance, and communication may be performed after establishing a communication connection using the connection information.

In addition, the wireless communication module may perform communication according to various communication standards such as IEEE, Zigbee, 3^{rd} Generation (3G), 3^{rd} Generation Partnership Project (3GPP), Long Term Evolution (LTE), or 5^{th} Generation (5G). The NFC module may perform communication using an NFC scheme in a 13.56 MHz band among various RFID frequency bands such as 135 kHz, 13.56 MHz, 433 MHz, 860 to 960 MHz, and 2.45 GHz. Further, the UWB module may accurately measure a time of arrival (ToA), which is a time for a pulse to reach a target, and an angle of arrival (AoA), which is an arrival angle of the pulse at a receiving apparatus, through communication between UWB antennas, thereby enabling precise distance and position recognition within an error range of several tens of centimeters indoors.

In particular, in one or more embodiments, the processor 120 may receive at least a portion of authentication data from an external apparatus through the communicator 130. In addition, the processor 120 may control the communicator 130 to transmit information regarding a message for requesting to set a group corresponding to a specific application, information regarding a message indicating that user authentication has failed, and the like, to an external apparatus (for example, another apparatus used by the same user as the electronic apparatus 100).

The input unit 140 includes circuitry, and the processor 120 may receive a user command for controlling operations of the electronic apparatus 100 through the input unit 140. The input unit 140 may be also referred to as an input interface. Specifically, the input unit 140 may include a microphone, a camera, and a remote control signal receiver. In addition, the input unit 140 may be implemented as a touch screen included in a display. In particular, the microphone may receive an audio signal, and convert the received audio signal into an electrical signal

In particular, in one or more embodiments, the processor 120 may receive, through the input unit 140, various user inputs such as a user input for registering biometric information, a user input for selecting a group corresponding to a plurality of group applications, a user input for deleting biometric information, and a user input for assigning biometric information to another group.

The output unit 150 includes circuitry, and the processor 120 may output various functions that the electronic apparatus 100 is capable of performing through the output unit 150. The output unit 150 may be also referred to as an output interface. The output unit 150 may include at least one of a display, a speaker, or an indicator.

The display may output image data under the control of the processor 120. Specifically, the display may output an image prestored in the memory 110 under the control of the processor 120. In particular, the display according to one embodiment of the present disclosure may display a user interface stored in the memory 110. The display may be implemented as a Liquid Crystal Display Panel (LCD), an Organic Light Emitting Diodes (OLED), or the like, and may also be implemented as a flexible display or a transparent display. However, the display according to the present disclosure is not limited to a specific type.

The speaker may output audio data under the control of the processor 120. The indicator may be turned on under the control of the processor 120. Specifically, the indicator may be turned on in various colors according to the control by the processor 120. For example, the indicator may be implemented as Light Emitting Diodes (LED), a Liquid Crystal Display Panel (LCD), or a Vacuum Fluorescent Display (VFD), but is not limited thereto.

In particular, in one or more embodiments, the processor 120 may control the output unit 150 to output a message for requesting to set a group corresponding to a specific application, a message indicating that user authentication has failed, and the like. For example, the message for requesting to set a group corresponding to a specific application, the message indicating that user authentication has failed, and the like may be output through a display in the form of a user interface including images and text, or may be output through a speaker in the form of voice.

Meanwhile, a controlling method of the electronic apparatus 100 according to the embodiments described above may be implemented as a program and provided to the electronic apparatus 100. In particular, a program including the controlling method of the electronic apparatus 100 may be stored and provided in a non-transitory computer-readable medium.

Specifically, in a non-transitory computer-readable recording medium including a program for executing the controlling method of the electronic apparatus 100, the controlling method of the electronic apparatus 100 may include receiving a user authentication request by a first application, identifying whether first biometric information of a user corresponding to the request is included in authentication data classified into a plurality of groups, identifying a first group corresponding to the first application among the plurality of groups when the first biometric information is included in the authentication data, allowing a user's access to the first application when the first group is identified and corresponds to authentication data including the first biometric information, and providing a message for requesting to set a group corresponding to the first application when the first group is not identified.

Although the controlling method of the electronic apparatus 100 and the computer-readable recording medium including a program for executing the controlling method of the electronic apparatus 100 have been briefly described above, this is merely to omit redundant description, and various embodiments of the electronic apparatus 100 may of course be applied to the controlling method of the electronic apparatus 100 and the computer-readable recording medium including the program for executing the controlling method of the electronic apparatus 100.

In one or more embodiments, an electronic apparatus may include: memory storing authentication data associated with a plurality of groups; and a processor configured to: receive a request for user authentication from a first application; based on first biometric information of a user regarding the request being obtained, identify whether the first biometric information is included in the authentication data; based on the first biometric information being included in the authentication data, determine whether a first group corresponding to the first application is identified from the plurality of groups stored in the memory; based on the first group being identified, and the first biometric information corresponding to authentication data included in the first group, allow the user to access the first application; and based on the first group not being identified, deny access to the first application for the user and provide a message requesting a group assignment for the first application.

The processor may be further configured to: receive a user input of the user in response to the message; and based on a second group among the plurality of groups being selected according to the user input, set the second group as a group corresponding to the first application, assign the first biometric information to the second group, and allow the user to access the first application.

The processor may be further configured to: based on second biometric information different form the first biometric information being assigned to the second group, and the second group being selected according to the user input, perform first additional user authentication based on the second biometric information; based on the first additional user authentication being successful, set the second group as the group corresponding to the first application; and based on the first additional user authentication failing, prevent assignment of the second group to the first application and set a third group different from the second group as the group corresponding to the first application.

The processor may be further configured to: based on no groups among the plurality of groups being selected by the user, set a default group for universal application authentication as the group corresponding to the first application.

The processor may be further configured to: based on the first biometric information not matching any of the authentication data, block the user's access to the first application, and provide a message indicating that user authentication for the first application has failed.

The processor may be further configured to: based on the first biometric information not corresponding to the authentication data included in the identified first group, block the user's access to the first application, and provide a message indicating that user authentication for the first application has failed.

The processor may be further configured to: based on a user input for the first biometric information after the first biometric information is assigned to the second group being received, identify whether second biometric information different from the first biometric information is assigned to the second group; based on the second biometric information being assigned to the second group, delete the first biometric information while maintaining the second group and the second biometric information in the authentication data; and based on the second biometric information not being assigned to the second group, delete information regarding the second group together with the first biometric information from the authentication data.

The processor may be further configured to: based on the second group being deleted, revert the first application to a default security state in which no biometric information is capable of performing user authentication.

The processor may be further configured to: based on data for the first application being deleted after the first biometric information is assigned to the second group, delete information indicating that the second group is set to perform user authentication for the first application from the authentication data.

The processor may be further configured to: based on the first group being identified, and the first biometric information corresponding to authentication data included in the first group, compare a first time at which the request is received with a second time at which the first biometric information is input; and based on the second time being later than the first time, block the user's access to the first application.

The processor may be further configured to: based on a user input for allocating the first biometric information to a third group different from the second group being received after the first biometric information is assigned to the second group, perform second additional user authentication based on at least one biometric information included in the third group; based on the second additional user authentication being successful, assign the first biometric information to the third group; and based on the second additional user authentication failing, maintain an original assignment of the first biometric information to the second group.

In one or more embodiments, a method of controlling an electronic apparatus may include: receiving a request for user authentication from a first application; based on first biometric information of a user regarding the request being obtained, identify whether the first biometric information is included in authentication data divided into a plurality of groups; based on the first biometric information being included in the authentication data, determine whether a first group corresponding to the first application is identified from the plurality of groups stored in the memory; based on the first group being identified, and the first biometric information corresponding to authentication data included in the first group, allowing the user to access the first application; and based on the first group not being identified, denying access to the first application for the user and providing a message requesting a group assignment for the first application.

The method may further include: receiving a user input of the user in response to the message; and based on a second group among the plurality of groups being selected according to the user input, setting the second group as a group corresponding to the first application, allocating the first biometric information to the second group, and allowing the user to access the first application.

The method may further include: based on second biometric information different form the first biometric information being assigned to the second group, and the second group being selected according to the user input, performing first additional user authentication based on the second biometric information; based on the first additional user authentication being successful, setting the second group as the group corresponding to the first application; and based on the first additional user authentication failing, preventing assignment of the second group to the first application and setting a third group different from the second group as the group corresponding to the first application.

The method may further include: based on no groups among the plurality of groups being selected by the user, setting a default group for universal application authentication as the group corresponding to the first application.

In one or more embodiments, a non-transitory computer-readable storage medium storing one or more instructions which, when executed by one or more processors of an electronic apparatus, may cause the electronic apparatus to: store authentication data associated with a plurality of groups in a memory; based on a request for user authentication from a first application, obtain first biometric information of a user; identify whether the first biometric information matches reference biometric data within the authentication data; based on the first biometric information matching the reference biometric data, identify whether the first biometric information corresponds to a first group assigned to the first application among the plurality of groups; based on the first biometric information corresponding to the first group, allow the user to access the first application; and based on the first application not corresponding to the first group, deny the user's access to the first application and provide a message for requesting to set a group corresponding to the first application.

The instructions may further cause the electronic apparatus to: receive a user input in response to the message; and based on a second group among the plurality of groups being selected according to the user input, link the second group to the first application, assign the first biometric information to the second group, and allow the user to access the first application.

The instructions may further cause the electronic apparatus to: detect at least one second biometric information different from the first biometric information is already assigned to the second group; based on a defection of the at least one second biometric information, perform a first additional user authentication based on the at least one second biometric information; and condition a setting of the second group as a group for the first application on a success of the first additional user authentication.

The machine-readable storage medium may be provided in the form of a non-transitory storage medium. Here, the term ‘non-transitory’ means that the storage medium is tangible without including a signal (e.g. electromagnetic waves), and does not distinguish whether data are semi-permanently or temporarily stored in the storage medium. For example, the ‘non-transitory storage medium’may include a buffer in which data is temporarily stored.

According to an embodiment, the methods according to various embodiments disclosed in the present disclosure may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore™) or directly between two user devices (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory 110 of a relay server or may be temporarily generated.

The components (e.g., modules or programs) according to various embodiments of the present disclosure may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration.

Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Meanwhile, terms “~er/or” or “module” used in the disclosure may include units configured by hardware, software, or firmware, and may be used compatibly with terms such as, for example, logics, logic blocks, parts, circuits, or the like. The “~er/or” or “module” may be an integrally configured part or a minimum unit performing one or more functions or a part thereof. For example, the module may be configured by an application-specific integrated circuit (ASIC).

Various embodiments of the present disclosure may be implemented in software including an instruction stored in a machine-readable storage medium (e.g., computer). The machine may be a device that invokes the stored instruction from the storage medium and is operated based on the invoked instruction, and may include an electronic apparatus (e.g., electronic apparatus 100) according to the embodiments disclosed herein.

In case that the instruction is executed by the processor, the processor may directly perform a function corresponding to the instruction or other components may perform the function corresponding to the instruction under control of the processor. The instruction may include codes provided or executed by a compiler or an interpreter.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

What is claimed is:

1. An electronic apparatus comprising:
memory storing authentication data associated with a plurality of groups; and
a processor configured to:
receive a request for user authentication from a first application;
based on first biometric information of a user regarding the request being obtained, identify whether the first biometric information is included in the authentication data;
based on the first biometric information being included in the authentication data, determine whether a first group corresponding to the first application is identified from the plurality of groups stored in the memory;
based on the first group being identified, and the first biometric information corresponding to authentication data included in the first group, allow the user to access the first application; and
based on the first group not being identified, deny access to the first application for the user and provide a message requesting a group assignment for the first application.

2. The electronic apparatus of claim 1, wherein the processor is further configured to:
receive a user input of the user in response to the message; and
based on a second group among the plurality of groups being selected according to the user input, set the second group as a group corresponding to the first application, assign the first biometric information to the second group, and allow the user to access the first application.

3. The electronic apparatus of claim 2, wherein the processor is further configured to:
based on second biometric information different form the first biometric information being assigned to the second group, and the second group being selected according to the user input, perform first additional user authentication based on the second biometric information;
based on the first additional user authentication being successful, set the second group as the group corresponding to the first application; and
based on the first additional user authentication failing, prevent assignment of the second group to the first application and set a third group different from the second group as the group corresponding to the first application.

4. The electronic apparatus of claim 3, wherein the processor is further configured to:
based on no groups among the plurality of groups being selected by the user, set a default group for universal application authentication as the group corresponding to the first application.

5. The electronic apparatus of claim 1, wherein the processor is further configured to:
based on the first biometric information not matching any of the authentication data, block the user's access to the first application, and provide a message indicating that user authentication for the first application has failed.

6. The electronic apparatus of claim 1, wherein the processor is further configured to:
based on the first biometric information not corresponding to the authentication data included in the identified first group, block the user's access to the first application, and provide a message indicating that user authentication for the first application has failed.

7. The electronic apparatus of claim 2, wherein the processor is further configured to:
based on a user input for the first biometric information after the first biometric information is assigned to the second group being received, identify whether second biometric information different from the first biometric information is assigned to the second group;
based on the second biometric information being assigned to the second group, delete the first biometric information while maintaining the second group and the second biometric information in the authentication data; and
based on the second biometric information not being assigned to the second group, delete information regarding the second group together with the first biometric information from the authentication data.

8. The electronic apparatus of claim 7, wherein the processor is further configured to:
based on the second group being deleted, revert the first application to a default security state in which no biometric information is capable of performing user authentication.

9. The electronic apparatus of claim 2, wherein the processor is further configured to:
based on data for the first application being deleted after the first biometric information is assigned to the second group, delete information indicating that the second group is set to perform user authentication for the first application from the authentication data.

10. The electronic apparatus of claim 1, wherein the processor is further configured to:
based on the first group being identified, and the first biometric information corresponding to authentication data included in the first group, compare a first time at which the request is received with a second time at which the first biometric information is input; and
based on the second time being later than the first time, block the user's access to the first application.

11. The electronic apparatus of claim 2, wherein the processor is further configured to:
based on a user input for allocating the first biometric information to a third group different from the second group being received after the first biometric information is assigned to the second group, perform second additional user authentication based on at least one biometric information included in the third group;
based on the second additional user authentication being successful, assign the first biometric information to the third group; and
based on the second additional user authentication failing, maintain an original assignment of the first biometric information to the second group.

12. A method of controlling an electronic apparatus, the method comprising:
receiving a request for user authentication from a first application;
based on first biometric information of a user regarding the request being obtained, identify whether the first biometric information is included in authentication data divided into a plurality of groups;
based on the first biometric information being included in the authentication data, determine whether a first group corresponding to the first application is identified from the plurality of groups stored in the memory;
based on the first group being identified, and the first biometric information corresponding to authentication data included in the first group, allowing the user to access the first application; and
based on the first group not being identified, denying access to the first application for the user and providing a message requesting a group assignment for the first application.

13. The method of claim 12, further comprising:
receiving a user input of the user in response to the message; and
based on a second group among the plurality of groups being selected according to the user input, setting the second group as a group corresponding to the first application, allocating the first biometric information to the second group, and allowing the user to access the first application.

14. The method of claim 13, further comprising:
based on second biometric information different form the first biometric information being assigned to the second group, and the second group being selected according to the user input, performing first additional user authentication based on the second biometric information;
based on the first additional user authentication being successful, setting the second group as the group corresponding to the first application; and
based on the first additional user authentication failing, preventing assignment of the second group to the first application and setting a third group different from the second group as the group corresponding to the first application.

15. The method of claim 14, further comprising:
based on no groups among the plurality of groups being selected by the user, setting a default group for universal application authentication as the group corresponding to the first application.

16. A non-transitory computer-readable storage medium storing one or more instructions which, when executed by one or more processors of an electronic apparatus, cause the electronic apparatus to:
store authentication data associated with a plurality of groups in a memory;
based on a request for user authentication from a first application, obtain first biometric information of a user;
identify whether the first biometric information matches reference biometric data within the authentication data;
based on the first biometric information matching the reference biometric data, identify whether the first biometric information corresponds to a first group assigned to the first application among the plurality of groups;
based on the first biometric information corresponding to the first group, allow the user to access the first application; and
based on the first application not corresponding to the first group, deny the user's access to the first application and provide a message for requesting to set a group corresponding to the first application.

17. The non-transitory computer-readable storage medium of claim 16, wherein the instructions further cause the electronic apparatus to:
receive a user input in response to the message; and
based on a second group among the plurality of groups being selected according to the user input, link the second group to the first application, assign the first biometric information to the second group, and allow the user to access the first application.

18. The non-transitory computer-readable storage medium of claim 17, wherein the instructions further cause the electronic apparatus to:
detect at least one second biometric information different from the first biometric information is already assigned to the second group;
based on a defection of the at least one second biometric information, perform a first additional user authentication based on the at least one second biometric information; and
condition a setting of the second group as a group for the first application on a success of the first additional user authentication.
